(19) United States
(12) Patent Application Publication
(10) Pub. No.: US 2014/0027693 A1
(43) Pub. Date: Jan. 30, 2014

(54) SCISSOR LIFT APPARATUS

(71) Applicant: Mopec, Inc., Oak Park, MI (US)

(72) Inventor: George Hallman, Washington, MI (US)

(73) Assignee: Mopec, Inc., Oak Park, MI (US)

(21) Appl. No.: 13/942,985

(22) Filed: Jul. 16, 2013

Related U.S. Application Data
(60) Provisional application No. 61/675,969, filed on Jul. 26, 2012.

(51) Int. Cl. B66F 5/00; B66F 7/06

(52) U.S. Cl. CPC B66F 5/00; B66F 7/065
USPC 254/8 C

(57) ABSTRACT

A lift for use in an autopsy, necropsy or pathology procedure comprises a base and a scissor lift connected to the base. A support member is connected to the scissor lift and a tray extraction device is aligned at a mid point of the support member. A console is attached to one end of the base and a steering and lifting arm extends from the console. The lift also comprises at least one outboard wheel arranged on an outer surface of the base and a pivoting steering wheel arranged below the console.

This application Claims Benefit to U.S. Provisional Patent Application Ser. No. 61/675,969—Filed Jul. 26, 2012

### BACKGROUND OF THE INVENTION

1. Field of the Invention

The present invention generally relates to a scissor lift apparatus and more particularly relates to a scissor lift apparatus for use with an autopsy table for transferring remains being autopsied from an autopsy table to a storage unit or vice versa.

2. Description of Related Art

Autopsy tables, grossing tables, necropsy tables and trimming tables are well known in the art along with carts and lifts used to transfer a body being autopsied from a storage unit to an autopsy table via a body tray or the like. During the autopsy of the body, the body must be transferred from the storage unit onto a body tray and then onto a cart, which may be used to transport the body tray and body to an autopsy table or the autopsy may be conducted directly on the cart, which may place the body tray at a predetermined angle to allow for drainage of a fluid to a predetermined area thereon.

Many of these prior art autopsy carts are typically used in hospitals, mortuaries, or scientific labs for moving patients or bodies from one location to another. Many of these prior art autopsy carts include a frame that has four ground engaging wheels, wherein the wheels are usually caster wheels that enable the trolley to be easily moved in any direction. The use of four wheels may allow for the autopsy cart to be capable of being used in tight areas allowing for positioning of the autopsy cart next to a location for transfer of a patient or body to and from the autopsy cart to an autopsy table or storage unit. Generally, the wheels of the prior art autopsy carts are free running and allow for movement of the cart in any direction, such that it is affected by an operative pushing or pulling of the cart in the desired direction. Many of these prior art autopsy carts are extremely heavy and may lead to undue stress and strain to the operators charged with moving bodies from storage to autopsy tables and the like.

Therefore, there is a need in the art for an improved scissor lift apparatus. There also is a need in the art for a scissor lift apparatus that is capable of turning in tight spaces and being maneuverable in a forward and rearward direction with ease. Furthermore, there is a need in the art for an improved scissor lift apparatus that has two outboard wheels arranged on a base to allow for a tight turning radius for the scissor lift apparatus. There also is a need in the art for a more robust and cheaper to manufacturer scissor lift apparatus than those of the prior art. There also is a need in the art for a scissor lift apparatus that has two powered outboard wheels and one pivoting inboard drive or steer wheel arranged near a console of the base thereof.

### SUMMARY OF THE INVENTION

One object of the present invention may be to provide a novel and unique scissor lift apparatus.

Another object of the present invention may be to provide a scissor lift apparatus that has a pair of outboard wheels arranged at a predetermined position on a base thereof.

Still another object of the present invention may be to provide a scissor lift apparatus that includes a pivoting drive wheel arranged near a rear console of the scissor lift apparatus.

Still another object of the present invention may be to provide a scissor lift apparatus that includes at least one guide wheel attached to an end of the base.

Still another object of the present invention may be to provide a scissor lift apparatus that includes a scissor lift type adjustable height mechanism that is capable of moving a body tray to different heights with relation to the base of the scissor lift apparatus.

Still another object of the present invention may be to provide a scissor lift apparatus that includes visual and audible alarms, along with an emergency stop and a motion assist lever used in conjunction with key lockout devices.

Still another object of the present invention may be to provide a scissor lift apparatus that has a body tray extraction device for use in moving a body tray from a storage device or autopsy table.

According to the present invention, the foregoing and other objects and advantages are obtained by a novel design for a scissor lift apparatus for use in autopsy, necropsy, or pathology procedures. The scissor lift apparatus includes a base member having a console attached to one end thereof. The scissor lift apparatus further includes a scissor lift attached to a base member at a predetermined position thereon. Attached to the opposite end of the scissor lift is a support member. The top support member has a tray extraction device aligned at a mid point thereof and extending along the entire length thereof. The tray extraction device may include a tray latching mechanism which is capable of movement along the tray extraction device to move a body tray from a storage unit onto the scissor lift support member and vice versa. A lifting and steering arm is arranged at a top surface of the console. The steering and lifting arm may allow for steering of the scissor lift apparatus and the raising and lowering of the scissor lift. The scissor lift apparatus also includes at least one outboard wheel arranged on an outer surface of the base member. In one contemplated embodiment a first and second outboard wheel is arranged on an outside surface of the base member at predetermined positions which may be at or near a mid point of the base member. Attached to each end of the base member opposite that of the console are a first and second guide wheel, which generally are arranged perpendicular to the outboard wheels, such that they generally are horizontal with respect to the ground on which the scissor lift apparatus moves. The scissor lift apparatus also includes a pivoting steering wheel arranged within or below the console to allow for steering of the scissor lift apparatus. It should be noted that either the steering wheel or the outboard wheels may be powered to provide powered motion to the scissor lift apparatus. The scissor lift may allow for the moving of bodies on a body tray secured to the tray latching mechanism of the present invention to be tilted to predetermined angles, or to be lifted and removed at certain predetermined heights depending on the storage and autopsy tables into which the body may be arranged.

One advantage of the present invention may be that it provides a novel and unique scissor lift apparatus.

Another advantage of the present invention may be that it provides for a scissor lift apparatus that has a base member with a console arranged on one end thereof.

Still another advantage of the present invention may be that it provides a scissor lift apparatus that includes a first and second outboard wheel arranged on the base member at or near a mid point of the base member.

Still another advantage of the present invention may be that it provides a first and second horizontal arranged guide wheel arranged on each end of the base opposite of that of the console.

Still another advantage of the present invention may be that it provides a scissor lift apparatus that includes a scissor lift connected to the base member on one end thereof and to a support member on the opposite end thereof.

Yet another advantage of the present invention may be that it provides for a scissor lift apparatus that includes a tray extraction device secured to the support member wherein the tray extraction device includes a tray latching mechanism to secure a body tray thereto.

Still another advantage of the present invention may be that it provides a scissor lift apparatus that includes a steering and lifting arm arranged on or connected to the console to steer and move a scissor lift apparatus.

Yet another advantage of the present invention may be that it provides for a steering wheel arranged in the console of the scissor lift apparatus.

Still another advantage of the present invention may be that it provides a scissor lift apparatus that is more robust and lower in costs and easier to maintain than those scissor lifts of the prior art.

Other objects, features and advantages of the present invention may become apparent from the subsequent description, and appended claims, taken in conjunction with the accompanying drawings.

### BRIEF DESCRIPTION OF THE DRAWINGS

FIG. 1 shows a perspective view of a scissor lift apparatus according to the present invention.

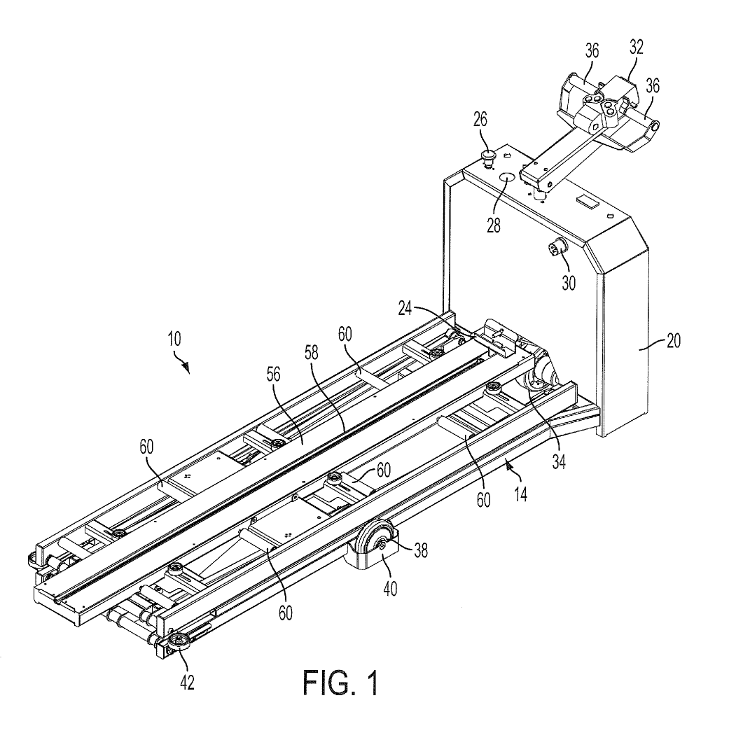

FIG. 2 shows a top view of the scissor lift apparatus according to the present invention.

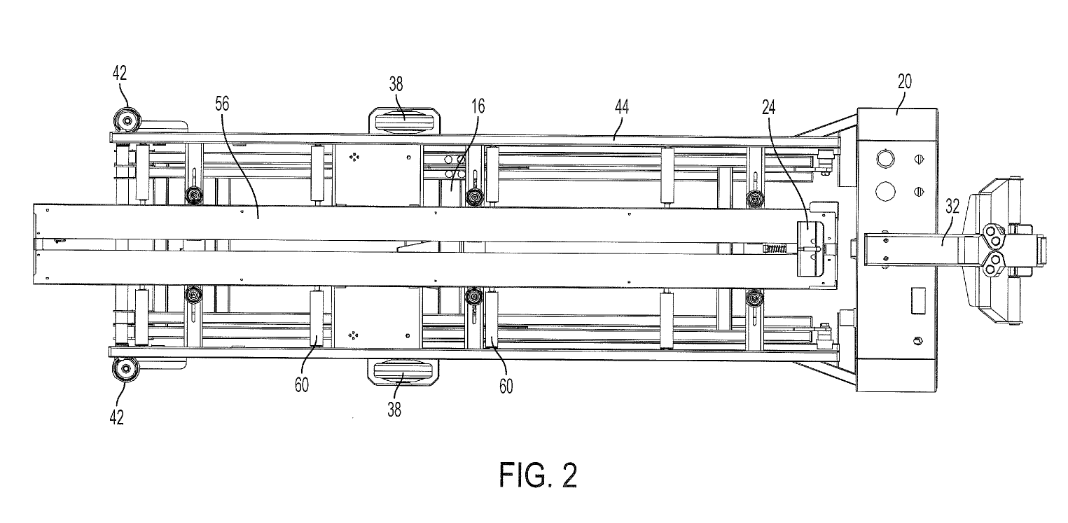

FIG. 3 shows side view of the scissor lift apparatus according to the present invention.

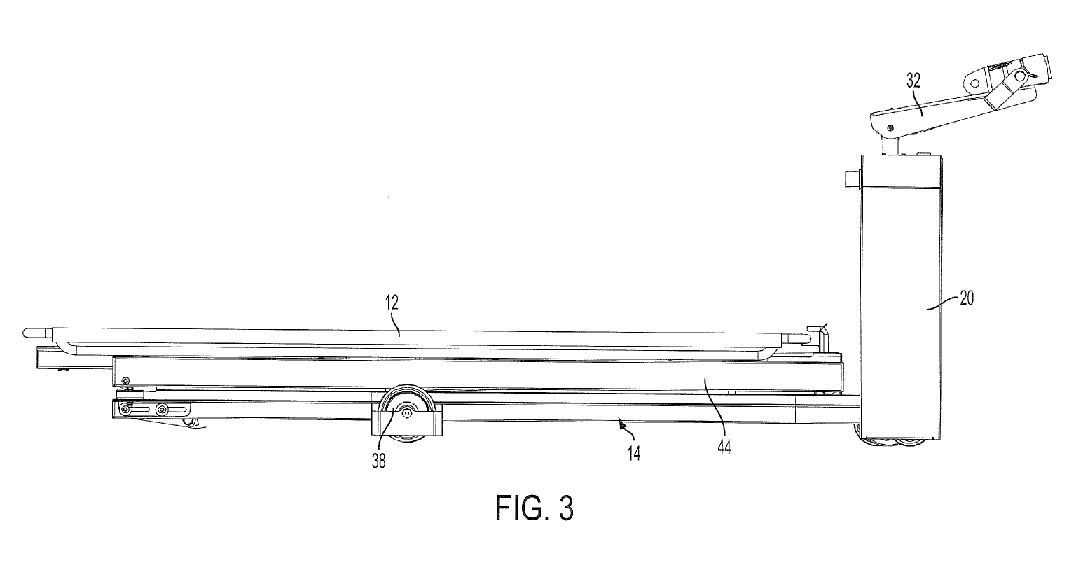

FIG. 4 shows an end view of the scissor lift apparatus according to the present invention.

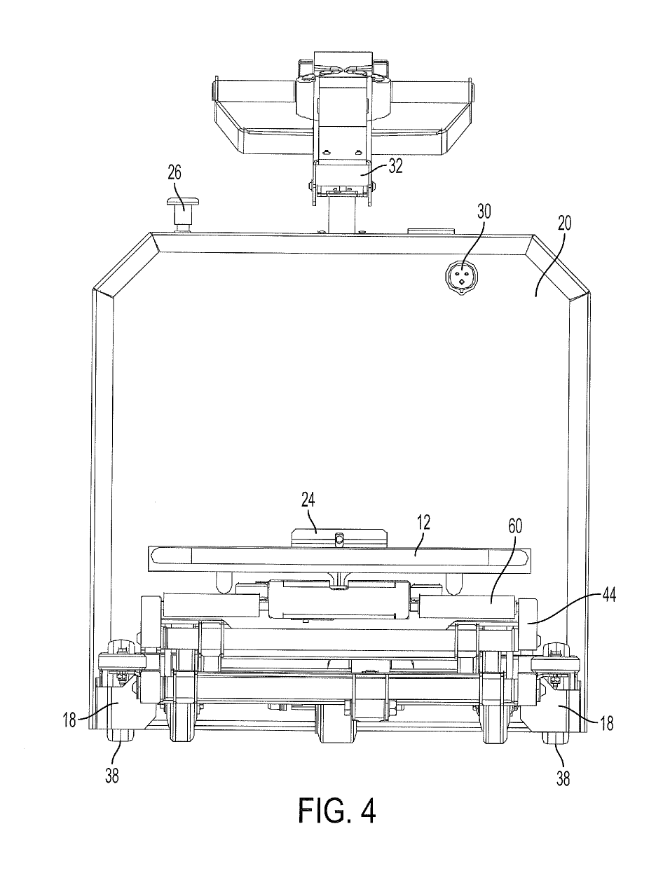

FIG. 5 shows a side view of the scissor lift apparatus with the scissor lift fully extended according to the present invention.

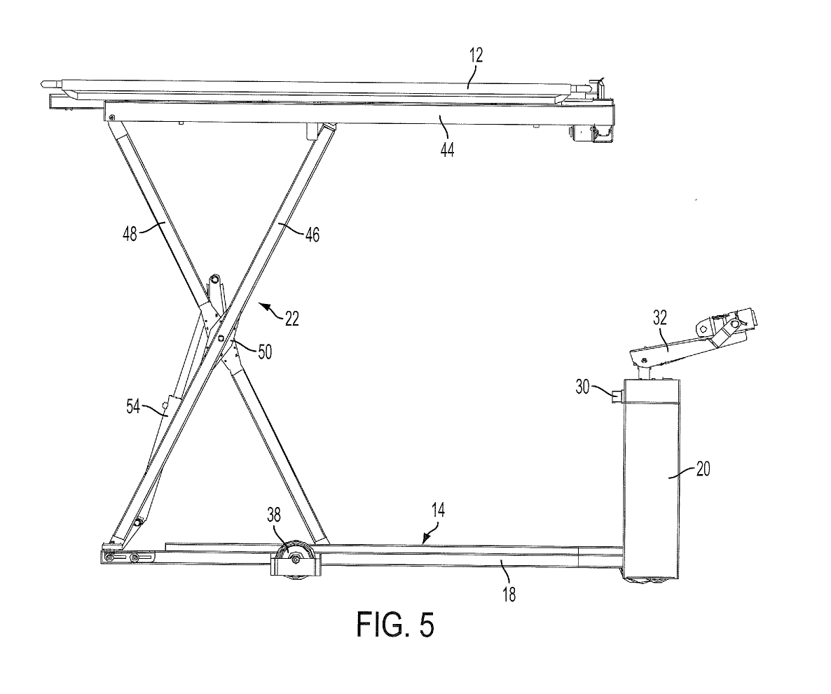

FIG. 6 shows a perspective view of a scissor lift apparatus according to an embodiment of the present invention.

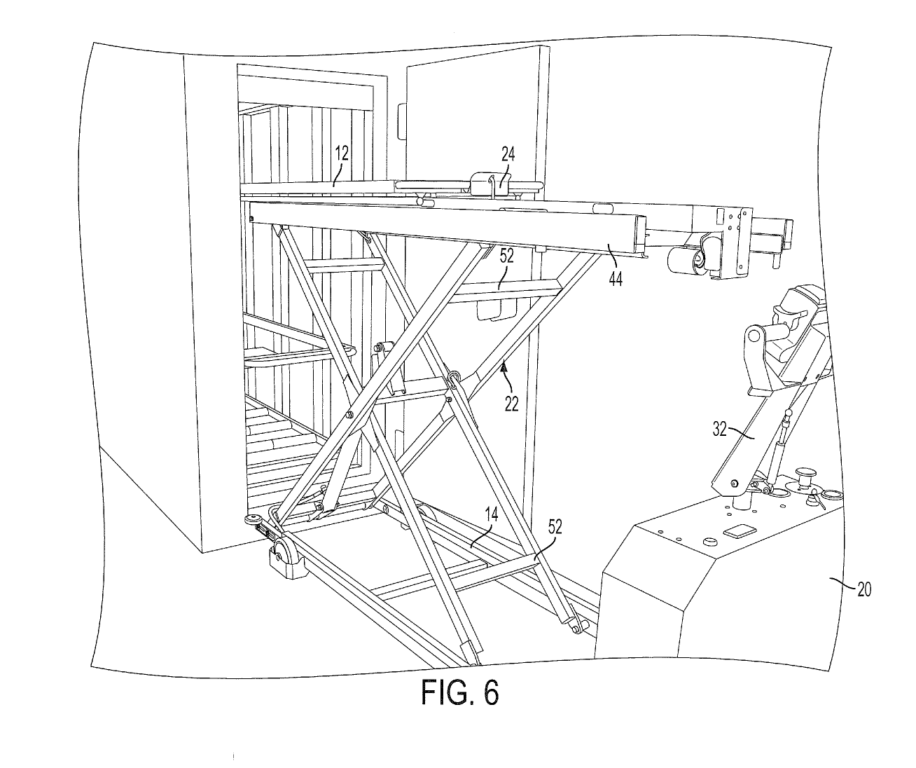

FIG. 7 shows a perspective view of a scissor lift apparatus according to an embodiment of the present invention.

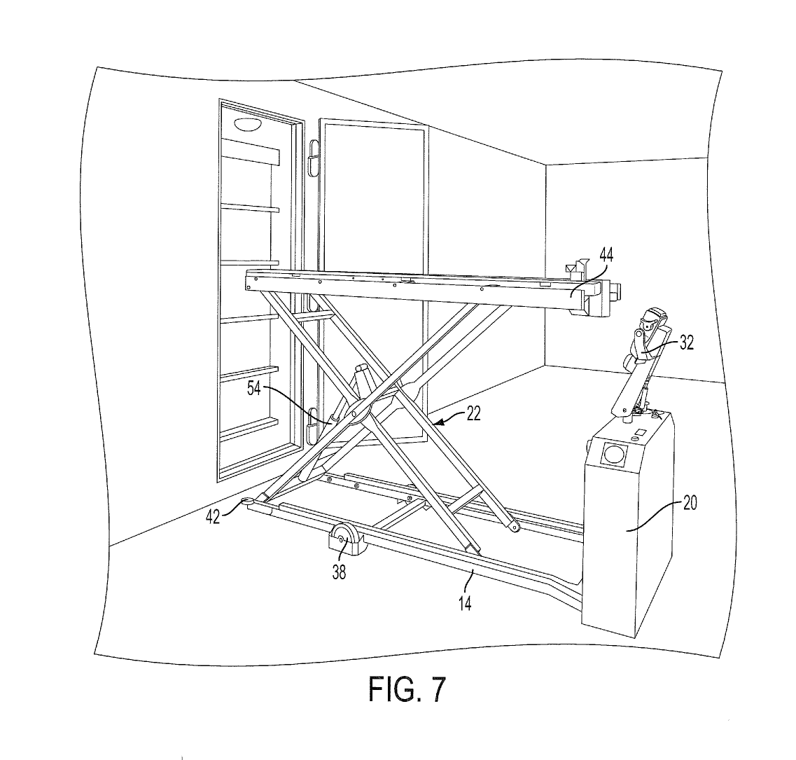

### DESCRIPTION OF THE EMBODIMENT(S)

Referring to the drawings, a scissor lift apparatus 10 that is capable of being adjusted to various heights is shown according to the present invention. It should be noted that the scissor lift apparatus 10 of the present invention may be used in any known autopsy, necropsy, trimming, pathology, or any other procedure performed on bodies, tissues or the like, all of which are for use in hospitals, morgues, funeral homes, laboratories, or any other structure that may be used for examining human or animal bodies or human or animal body parts. Generally, the scissor lift apparatus 10 may be used to provide a means for moving a body tray 12, which have a body arranged thereon and generally have a horizontal orientation, between a storage unit and an autopsy table or an embalming table or the like. The scissor lift apparatus 10 of the present invention may be capable of tilting the body tray 12 at any predetermined angle to allow for easy removal or entry onto the scissor lift apparatus 10 according to the present invention. The scissor lift apparatus 10 of the present invention may also be capable of being steerable in small confined places to allow for use in any size autopsy, laboratory, or hospital room or setting. The scissor lift apparatus 10 of the present invention may also be robust enough to handle the heavy weights involved with moving and transporting bodies for autopsy, or other pathology procedures. The scissor lift apparatus 10 of the present invention may also reduce the strain on the person obligated to move the body from a storage area to an autopsy table or the like through use of powered wheels to allow for easy movement in lifting and attaching the body tray thereon.

The scissor lift apparatus 10 of the present invention generally may include a base or base member 14 that has a generally rectangular shape. The base 14 in one contemplated embodiment as shown in the drawings is made of a steel material however any other known material, such as metal, plastic, ceramic, composite or nature material may also be used to form the base 14. The base 14 generally is formed from a first and second metal beam or tube 18 arranged parallel to one another, with at least one, but in one contemplated embodiment a plurality of cross member 16, arranged therebetween. It should be noted that the cross section of the cross members 16 and the beam members 18 may be of any known shape, such as but not limited to square cross sections, rectangular cross sections, circular cross sections, oval cross sections, or any other known shape.

The scissor lift apparatus 10 also may include a console 20 secured to one end of the base member 14 according to the present invention. The console 20 may have any known shape including the rectangular container like shape as shown in the figures. The console 20 may extend a predetermined height from the base member 14 in a generally vertical direction with relation to the horizontal beam members 18. The console 20 may have a predetermined height, width and length to allow for internal storage of electronics, wiring, fans, etc., to control the operation of the scissor lift apparatus 10. The console 20 also may include electronic controls and switches that control a visual alarm, an audible alarm, an operation confirmation control, a scissor lift mechanism along with a tray extraction mechanism. The console 20 may also include a key lockout device, a scissor lift switch to control up and down movement of the scissor lift 22 and a tray extraction controller device to control the horizontal directional movement of a tray latching mechanism 24 to move a body tray 12 onto or off of the scissor lift apparatus 10. The console 20 may also include an emergency stop button 26 to allow for stopping of all movement of the scissor lift 22 and scissor lift apparatus 10. The console 20 may also include a display 38 or plurality of displays that are capable of showing the status of any operation such as but not limited to battery power level and any fault codes encountered by the scissor lift apparatus 10 during operation or use thereof. The console 20 may also include a fan to cool the inner electronics located within the console 20 and may even include a plug 30 and/or attachments to allow for electrical connections and other types of connections to be made to the scissor lift apparatus 10.

The console 20 may also include a steering and lift arm 32 arranged therein. In one contemplated embodiment the steering and lift arm 32 may be arranged through a top surface of the console 20 and may extend through the interior of the console 20 and connect to a steering wheel 34 which is attached to an end of the base member 14 of the scissor lift apparatus 10. The steering arm 32 may be capable of rotating in a 360° arch to allow for easy movement and maneuverability of the scissor lift apparatus 10 in tight spaces. The scissor lift steering arm 32 may also be capable of pivoting with respect to the top of the console 20 in a vertical plane to either control movement of the scissor lift 22 or to adjust the height of the base 14 of the scissor lift apparatus 10. In one contemplated embodiment the steering arm 32 may have a first and second grip or handle 36 arranged thereon, but any other configuration for the steering arm is also contemplated. The steering arm 32 also may have motion assist levers on the grips 36 to allow for motion assistance in moving the scissor lift apparatus 10 with body and body tray 12 arranged thereon. The motion assist levers may be capable of moving the scissor lift apparatus 10 in a forward or rearward direction depending on the user of the scissor lift apparatus 10. It should be noted that all of the parts described herein are generally made of a steel material, however any other metal, ceramic, plastic, composite or any other natural material may also be used to form all of the parts described above.

It should be noted that the steering wheel 34 may include a plurality of wheels arranged side by side or a single wheel attached via any known wheel, spoke, axle or hub arrangement in order to have rotation of 360° of the wheel 34 with respect to the base member 14. The steering wheel 34 may also have power applied to it by a motor, etc., to provide automatic motion of the scissor lift apparatus 10. The axle or hub of the steering wheel 34 may be connected to the base 14 or console 20.

The scissor lift apparatus 10 of the present invention also may include a first and second outboard wheel 38 arranged at predetermined position on the outer frame members 18 of the base 14. The outboard wheels 38 may be powered by a motor or may not be powered and may be freewheeling. In one contemplated embodiment the outboard wheel 38 may be arranged a predetermined distance from one end of the base 14 and from a mid point of the base 14 or may be arranged near or at the midpoint of the base 14. It is also contemplated to use one outboard wheel 38 or any other number greater than two. The positioning of the wheel 38 between a mid point and one end of the base 14 at any particular point thereon may allow for a predetermined turning arc to be performed or to be capable of occurring when used by the operator of the scissor lift apparatus 10. Any known connection to the base member frame 18 may be used for the wheels, such as a wheel and sprocket, hub, axle, etc. The outboard wheels 38 may also include a fender 40 extending from the frame 18 around the outboard wheels 38 to allow for a sprocket or axle to be arranged between the fender 40 and the frame member 18 of the base 14. Any known wheel and rim may be used for both the steering wheel 34 and the outboard wheels 38 of the present invention. The base 14 may also include at least one guide wheel 42 which may be arranged on an end of the base 14. The guide wheel 42 may be arranged at each end of the frame member 18 of the base 14 and generally may be arranged horizontal with respect to the ground on which the base member 14 is arranged. The sprocket or axle of the guide wheel 42 may be perpendicular to the sprocket or axle of the outboard wheels 38 arranged on the base member 14. The guide wheel 42 may allow for contact with walls or other surfaces and allow for precise positioning of the scissor lift apparatus 10 and the body tray 12 arranged thereon. Any known axle, rim, hub or sprocket configuration may be used for the guide wheels 42, such as that description for both the steering wheel and the outboard wheels 38 of the base member 14.

The scissor lift apparatus 10 of the present invention may also include a scissor lift 22 connected to the base member 14 on one end thereof and to a support member 44 on the opposite end thereof. The scissor lift 22 generally may comprise a first and second lift member 46, 48 connected to one another at a predetermined pivot point 50. Each lift member 46, 48 generally may have a first and second frame with at least one cross member 52 arranged therebetween. It should be noted that the frames for the scissor lift 22 may be of any known cross section shape or shape, such as but not limited to square, rectangle, round, triangular, oval, or any other known shape. A lift mechanism 54 is arranged between one of the cross members 52 of one of the lift members 46 of the scissor lift 22 and a cross member 52 of the other lift member 48 of the scissor lift 22. The lift mechanism 54 may allow for the scissor lift 22 to rise to a height at a predetermined final position. In one contemplated embodiment, the lift mechanism 54 is a pneumatic member or jack, however any other type of lift mechanism may also be used, including but not limited to a screw rod lift mechanism, etc. Generally, with the scissor lift 22 one end of one of the lift members 46 and one end of the other lift member 48 is secured at a pivot point at a front of the base member 14 and at a front of the support member 44 thereof. The opposite end of the lift member 46, 48 is pivotably supported in a slot or track of either the base member 14 or support member 44. Therefore, the scissor lift 22 is capable of moving the support member 44 of the scissor lift apparatus 10 between the level of the base member 14 and a predetermined final height away from the base member 14. It should be noted that it is also possible to tilt the support member 44 with relation to the base member 14 to allow for the body tray 12 to be placed at a predetermined angle with respect to a table or storage area.

The support member 44 is secured to the scissor lift 22 on an end opposite that of the base member 14. The securing of the support member 44 to the scissor lift 22 is described above. The support member 44 generally has a rectangular shape that includes at least a first and second frame with at least one, but preferably a plurality of cross members arranged therebetween. It should be noted that the support member 44 may be made of any known material, but preferably is made of a steel material, however any other metal, ceramic, plastic, composite, or natural material may be used for the support member 44 as well all other components of the scissor lift apparatus 10 according to the present invention. The support member 44 also includes a tray extraction device 56 arranged along an entire length thereof at a mid point of the support member 44. The tray extraction device 56 generally has a rectangular shape when viewed in cross section and when viewed from above. The tray extraction device 56 also may have a track 58 along a mid point thereof that allows for the tray latching mechanism 24 to be movably supported within the track 58 of the tray extraction device 56. In one contemplated embodiment a threaded rod mechanism may move the tray latch mechanism 24 along the slot of the tray extraction device 56 from one end of the support member 44 to the opposite end of the support member 44. In one contemplated embodiment the tray extraction device 56 may extend a predetermined distance beyond the end of the support member 44. The tray extraction device 56 may be secured to the cross members of the support member 44. A plurality of rollers 60 may also be arranged between the frame of the support member 44 and the tray extraction device 56 and also be connected to the frame of the support member 44 along the sides of the tray extraction device 56. The rollers 60 may be in the form of tube rollers or in the form of wheels that may engage with the body tray 12 to move the body tray 12 from a storage area to a secured position on the support member 44 of the scissor lift apparatus 10 and then moved from the scissor lift apparatus 10 to an autopsy table or final resting place for the body and associated body tray 12. The tray latching mechanism 24 may include any type of locking mechanism that is capable of both grabbing and locking the body tray 12 and securing the body tray 12 to the support member 44 of the scissor lift apparatus 10. The locking mechanism may be any known locking mechanism, such as a spring loaded locking mechanism using a rod or any other type of locking shoulder and clip mechanism. The wheels and rollers 60 of the support member 44 may engage with the underside of the body tray 12 to move the body tray 12 along the support member 44 via the tray extraction device 56 and tray latching mechanism 24. This may allow for quick loading and removal of the body tray 12 onto and from the scissor lift apparatus 10. It should be noted that any other type of lifting or moving mechanism other than a screw rod mechanism may be used to move the body tray 12 such as but not limited to a pulley system, a hydraulic mechanism, etc. The body tray 12 generally is a rectangular slab that has raised edges generally raised at a predetermined angle, but may also have any known angle and a connecting mechanism that may secure to the tray latching mechanism 24 of the scissor lift apparatus 10. The body tray 12 may also include a first and second rail arranged along a bottom portion thereof that may interact with the rollers and wheels 60 of the support member 44 to allow for moving onto and off of the support member 44 of the body tray with or without a body arranged thereon. It should be noted that wiring may be run along or in the frame members of the support member 44, scissor lift 22, and the base member 14, to the console 20 to allow for movement of the tray latching mechanism 24 with relation to the support member 44, the scissor lift 22 and rotation of either the outboard wheels 38 or the drive wheel 34 of the present invention.

The present description is for illustrative purposes only and should not be construed to limit the present invention in any way. Thus, the person skilled in the art will appreciate that modifications might be made to the present and disclosed embodiments without departing from the scope and spirit of the present invention, which is defined in terms of the claims below. Other aspects, features and advantages may be apparent upon the examination of the attached drawing figures and appended claims.

What is claimed is:

1. A lift for use in autopsy, necropsy or pathology procedure, said lift comprising:
a base;
a scissor lift connected to said base;
a support member connected to said scissor lift;
a tray extraction device aligned at a midpoint of said support member;
a console attached to one end of said base;
a steering and lifting arm extending from said console;
at least one outboard wheel arranged on an outer surface of said base; and
a pivoting steering wheel arranged below said console.

2. The lift of claim 1 wherein said console having a generally rectangular container like shape.

3. The lift of claim 1 wherein said console having electronic controls and switches.

4. The lift of claim 3 wherein said console having a display and a fan, said fan arranged to cool an interior of said console.

5. The lift of claim 1 wherein said steering and lifting arm is arranged through a top surface of said console.

6. The lift of claim 1 wherein said steering and lifting arm is connected to said pivoting steering wheel.

7. The lift of claim 1 wherein said steering and lifting arm rotates in a 360° arc with relation to said console and pivots with respect to a top surface of said console.

8. The lift of claim 1 wherein said pivoting steering wheel is capable of 360° of rotation in both a radial and axial direction.

9. The lift of claim 1 wherein said outboard wheel and/or said pivoting steering wheel is powered.

10. The lift of claim 1 wherein said outboard wheel is arranged at or near a midpoint of said base.

11. The lift of claim 1 further comprising a fender extending from said base and around said outboard wheel.

12. The lift of claim 1 further comprising a second outboard wheel arranged on an opposite side of said base from said at least one outboard wheel.

13. The lift of claim 1 further comprising at least one guide wheel arranged on an end of said base.

14. The lift of claim 1 wherein said support member is capable of being tilted with relation to said base.

15. The lift of claim 1 further comprising a tray latching mechanism engaged with said tray extraction device.

16. A lift, said lift comprising:
a base;
a console attached to one end of said base;
a scissor lift connected to said base;
a support member connected to said scissor lift;
a tray extraction device movably connected to and aligned at a midpoint of said support member;
a steering and lifting arm extending from said console;
a pivoting steering wheel connected to said steering and lifting arm;
a first outboard wheel connected to a first side of said base; and
a second outboard wheel connected to a second side of said base.

17. The lift of claim 16 wherein said first and second outboard wheel are positioned between a midpoint and one end of said base.

18. The lift of claim 16 further comprising at least one guide wheel arranged on one end of said base.

19. The lift of claim 16 further comprising a second guide wheel arranged on one end of said base.

20. The lift of claim 16 further comprising a tray latching mechanism engaged with said tray extraction device.
